(19) United States
(12) Patent Application Publication
(10) Pub. No.: US 2010/0037263 A1
(43) Pub. Date: Feb. 11, 2010

(54) METHOD AND APPARATUS FOR SCHEDULING INTERACTIVE CONTENT IN A BROADCAST COMMUNICATION SYSTEM

(75) Inventors: XAVIER D. RILEY, Los Angeles, CA (US); LONNIE S. CLABAUGH, San Pedro, CA (US); PHILIP F. KUAN, Torrance, CA (US); KSATRIA G. WILLIAMS, Garden Grove, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: THE DIRECTV GROUP, INC., EL SEGUNDO, CA (US)

(21) Appl. No.: 12/492,981

(22) Filed: Jun. 26, 2009

Related U.S. Application Data
(60) Provisional application No. 61/087,321, filed on Aug. 8, 2008.

(51) Int. Cl. H04N 5/445; H04N 7/173; H04N 7/20

(52) U.S. Cl. 725/50; 725/93; 725/97; 725/64

(57) ABSTRACT

A system and method for communicating with a user device includes an interactive head end and a broadcast channel management system communicating content channel data to the interactive head end. The interactive head end forms a streaming service in response to the content channel data and communicates interactive content to the user device in response to the streaming service.

### TECHNICAL FIELD

The present disclosure relates generally to a communication system, and, more specifically, to a system and method for scheduling content for distribution by the communication system.

### BACKGROUND

The statements in this section merely provide background information related to the present disclosure and may not constitute prior art.

Satellite television is increasing in popularity due to the ever-increasing amount of programming as well as the quality of programming. Programming includes standard national (CONUS) broadcasts, local or regional station broadcasts, on-demand content and interactive content. Interactive content is increasing in popularity.

Satellite television broadcast systems typically use several satellites. Each satellite has several transponders that receive signals from the ground and broadcast the signals to users. Each transponder is capable of providing a certain amount of content therethrough. That is, each transponder may provide a certain bit rate therethrough.

As the channels change from different levels or quality of content, such as high definition versus standard definition, the bit rates may change. Also, satellite programming provides occasional programming or channels that are not constantly broadcast. Pay-per-view content, sporting events and interactive television are examples of occasional content that is provided.

Interactive content must be scheduled so that it can be directed to users at a particular time. However, scheduling interactive content may be a cumbersome task. In a broadcast system providing errors in scheduling may leave dead air and thus reduce customer satisfaction.

### SUMMARY

The present disclosure provides a system for conveniently and accurately scheduling content suitable for interactive content.

In one aspect of the disclosure, a method includes receiving content channel data from a broadcast channel management system, forming a streaming service from streaming service data and content channel data and, in response to the streaming service, communicating content to user devices.

In another aspect of the disclosure, a method includes receiving content channel data from a broadcast channel management system and an interactive content scheduler, forming a streaming service from streaming service data and content channel data at the interactive content scheduler, forming a reservation corresponding to the streaming service, storing the reservation in a database, communicating a message to an interactive streaming server in response to the interactive content scheduler, in response to the reservation, communicating content to user device using the interactive content scheduler and communicating a channel object to a program guide system corresponding the streaming service.

In a further aspect of the disclosure, a system for communicating with a user device includes an interactive head end and a broadcast channel management system communicating content channel data to the interactive head end. The interactive head end forms a streaming service in response to the content channel data and communicates interactive content to the user device in response to the streaming service.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a system level view of the communication system according to the present disclosure.

FIG. 2 is a block diagrammatic view of the broadcast system 14 of FIG. 1.

FIG. 3 is a more detailed block diagrammatic view of the broadcast system of FIG. 1.

FIG. 4 is a block diagrammatic view of the interactive content head end in association with the advance program guide system and the broadcast operation channel management system.

FIG. 5 is a flowchart of a method for operating the interactive content scheduler.

FIG. 6 is a flowchart of a method for changing an existing content channel configuration.

FIG. 7 is a user interface for creating a streaming service.

FIG. 8 is a user interface for a streaming service manager.

FIG. 9 is a user interface for selecting a content channel.

FIG. 10 is a user interface for editing a content channel.

FIG. 11 is a user interface for editing content channels of a particular streaming service.

FIG. 12 is a user interface for creating a reservation.

FIG. 13 is a user interface illustrating or for editing reservations of a particular streaming service.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical or. It should be understood that steps within a method may be executed in different order without altering the principles of the present disclosure.

The present disclosure is set forth with respect to a satellite broadcast television system. In particular, the following disclosure is made with respect to DIRECTV® broadcast services and systems. It should be understood that many other delivery systems are readily applicable to disclosed systems and methods. Such systems include other wireless distribution systems, wired or cable distribution systems, cable television distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), Internet-based distribution systems, cellular distribution systems, power-line broadcast systems, any point-to-point and/or multicast Internet Protocol (IP) delivery network, and fiber optic networks. Further, the different functions collectively allocated among a head end (HE), integrated receiver/decoders (IRDs) and a content delivery network (CDN) as described below can be reallocated as desired without departing from the intended scope of the present patent.

Further, while the following disclosure is made with respect to the delivery of video (e.g., television (TV), movies, music videos, etc.), it should be understood that the systems and methods disclosed herein could also be used for delivery of any media content type, for example, audio, music, data files, web pages, etc. Additionally, throughout this disclosure reference is made to data, content, information, programs, movies, assets, video data, etc., however, it will be readily apparent to persons of ordinary skill in the art that these terms are substantially equivalent in reference to the example systems and/or methods disclosed herein. As used herein, the term title will be used to refer to, for example, a movie itself and not the name of the movie.

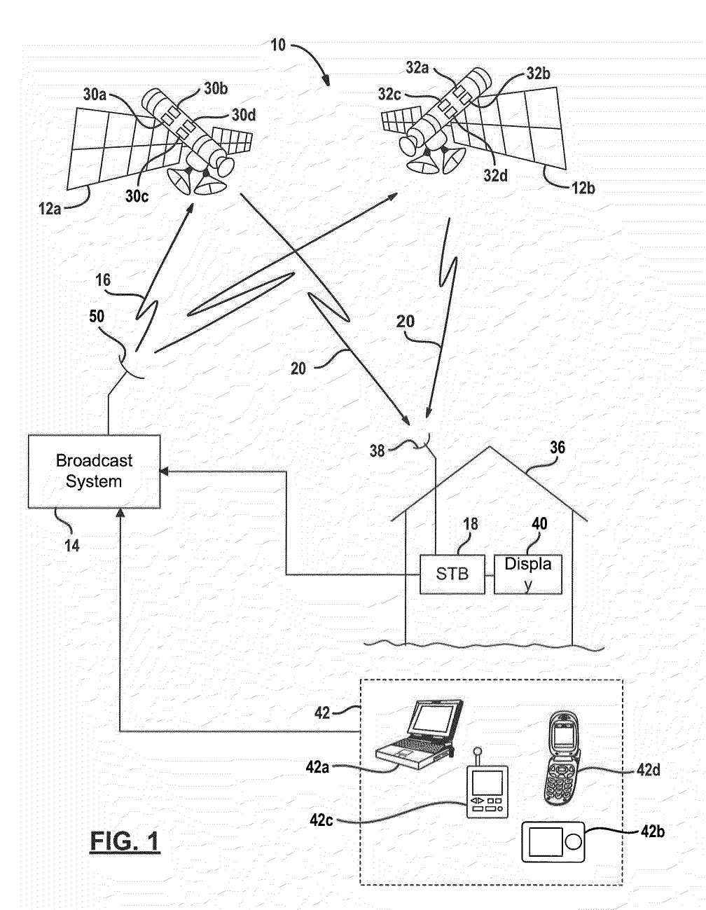

Referring now to FIG. 1, a satellite communication system 10 is illustrated having a first satellite 12a and a second satellite 12b. The communication system 10 may be a satellite television system or data distribution system.

The system 10 may include a broadcast system 14 for generating uplink signal 16 to the satellites 12a and 12b. The signals may correspond to various channel streams or multiplex channel streams that are communicated from the satellites 12a, 12b to a fixed user device 18 through downlinks 20. Only one user device 18 is illustrated by way of example. However, a system 10 may include several user devices.

Satellite 12a may include a plurality of transponders of which four are illustrated as reference numerals 30a-30d. The satellite 12b may also include a plurality of transponders including transponders 32a-32d. The transponders 30a-30d and 32a-32d receive the uplink signals from the broadcast system 14 and direct the signal, such as television signals, through the downlinks 20 to various users. The downlink signals 20 may be Continental United States (CONUS) or may be spot beam signals. As will be further described below, various allocations of channel signals to the various transponders may be provided. Transponders 30a, 30b, 32a and 32b are uplink transponders. Transponders 30c, 30d, 32c and 32d are downlink transponders. Although only four are illustrated, several different uplink transponders and downlink transponders may be provided in each satellite.

The user device 18 may comprise a set top box (STB) disposed within a home or business 36. An antenna 38 is used to receive the downlink signals 20 and provide them to the user receiving device 18. The user receiving device 18 may be in communication with a display 40 for displaying the channel signals. The user device 18 may communicate interactive signals to the broadcast system 14 through various means include a wired or wireless network.

Another type of user device may also be included in the system, a mobile receiving device 42. A plurality of mobile receiving devices is illustrated in box 42. A portable computer 42a, a portable media player 42b, a personal digital assistant 42c and a cellular telephone 42d are illustrated. Each of the devices includes an antenna that may be integral therewith for receiving the downlink signals 20. Different types and numbers of mobile devices may also be included in the system. It should be noted that both fixed and mobile user devices may be included. Of course, either fixed or mobile alone may be used in a system. The mobile device 18 may also communicate interactive signals to the broadcast system 14 through various means include a wired or wireless network.

The broadcast system 14 includes an antenna 50 for uplinking uplink signal 16 to satellites 12a and 12b. Although only one antenna 50 is illustrated for simplicity purposes, more than one antenna may be used.

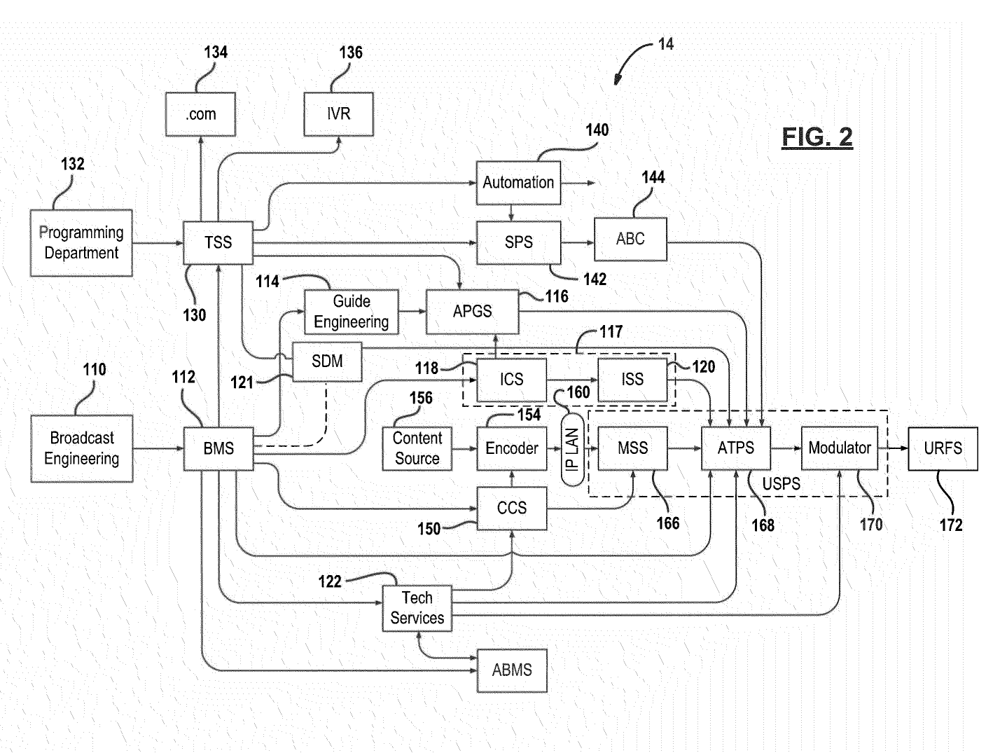

Referring now to FIG. 2, a block diagrammatic view of the broadcast system 14 of FIG. 1 is illustrated in further detail. The broadcast system 14 includes a broadcast engineering module 110 that is used for providing various inputs to a broadcast operation channel management system (BMS) 112. One example of a BMS system is set forth in application Ser. No. 12/041,952, entitled “Asset Allocation System and Method for Allocating Satellite Resources in a Satellite Broadcast Communication System” filed on Mar. 4, 2008, the disclosure of which is incorporated by reference herein. The BMS system 112 is used to allocate the resources of the satellites 12a and 12b illustrated in FIG. 1. Each transponder in the satellites is capable of providing various throughput which is referred to as a bit rate. The BMS system 112 provides a centralized and automated system to manage and maintain the information for a bit rate allocation chart in a database and communicates various data to various components of the broadcast system 14.

The BMS 112 may provide boot packet identifiers (PIDs) and rates to a guide engineering module 114. Guide engineering 114 may receive the data in various formats including email. Guide engineering 114, in turn, uses the information received to form the program guide in the advanced program guide system 116.

The BMS 112 may also be used to provide channel and program identifier assignments to an interactive content head end 117 that includes an interactive content scheduler (ICS) 118. The ICS 118 may provide various data to an interactive streaming server (ISS) 120. The interactive content scheduler 118 provides functions for creating a streaming service, associating content channels with the service, scheduling the services, informing the advance programming guide system 116 of changes in the channel objects and requesting the interactive streaming server 120 to broadcast the streaming services and necessary metadata. Content channels may not correspond to what is thought of as a broadcast channel. That is, Content channels may correspond to a broadcast channel but may also include several broadcast channels.

The ISS 120 executes the broadcast schedule provided by the interactive content scheduler. The ISS 120 performs the necessary data packetization and broadcasts the data files at the broadcast event time specified by the interactive content scheduler 118. The functions of the interactive content scheduler and the interactive streaming server will be described below.

The BMS 112 may provide interactive television (iTV) channel data, PID assignments and rates via XML to the ICS 118.

The BMS 112 may also be in communication with a software download manager (SDM) 121. The BMS 112 may interface with the SDM 121 and the ICS 118 using an XML-based web service. The SDM 121 may receive SWDL channel, data PID assignments and rates from the BMS 112.

The BMS 112 may also be in communication with a technical services module 122. The technical services module 122 may receive various bit rate allocation chart information. Bit rate allocation chart information may also be provided from the BMS 112 to an advanced broadcasting monitoring system (ABMS) 124. The advanced broadcasting monitoring system 124 may be used to monitor the quality of signals throughout various portions of the broadcasting system 14.

The BMS 112 may also provide channel definition and mapping data to a traffic and scheduling system 130. The traffic scheduling system 130 may receive a program schedule from a programming department 132. The traffic and scheduling system 130 may generate schedules to a dot corn module 134 used for ordering various content through an external computer interface. The data from the traffic and scheduling system 130 may also be provided to an interactive voice recognition (IVR) system 136 that also may be used to order various content.

The TSS 130 may provide guide channel data to the software download manager 121. A listing service within the TSS 130 may provide the guide channel data.

The traffic and scheduling system 130 may also provide scheduling information to an automation system 140. The automation system and the traffic and scheduling 130 may be in communication with a scheduled pad server 142. The scheduled pad server 142 may receive program-associated data (PAD). The scheduled pad server 142 delivers program-associated data to an advance broadcast controller 144.

The BMS 112 may provide compression control system configuration data to a compression control system 150. The compression control system 150 may provide data to an encoder 154. The compression control system 150 may provide the data to the encoder 154 for configuring the encoder 154. The encoder 154 may receive content from a content source 156. The content source 156 may various live content sources provided from satellite or fiber. The content sources may also be based on file or tape-based content received from a content repository. The encoder 154 may be used to encode the various content from the content source 156 according to the configuration provided from the compression control system 150. The encoder 154 may communicate the encoded signals through a local area network such as an Internet protocol local area network 160. Of course, various numbers of encoders 154 may be provided.

The output of the encoders may be referred to as a single program transport stream (SPTS). The local area network 160 may include a plurality of routers or the like to route the single transport streams to one of a plurality of uplink signal processing systems 164. Each uplink signal processing system may correspond to the output of a single transponder within one of the satellites 12a, 12b.

The uplink signal processing system 164 may include a multiplexing splicing system (MSS) 166, an advanced transport processing system (ATPS) 168 and a modulator 170. Although not shown, multiple components within the uplink signal processing system may have redundant systems.

The advance transport processing system 168 may receive various data signals from the advance broadcast controller 144, the advance program guide system 116, the interactive streaming server 120 of the interactive head end 117, the BMS 112 and technical services 122. The multiplexing splicing system 166 may also receive configuration information from the compression control system 150. The compression control system 150 may generate configurations so that the multiplexing splicing system 166 receives the desired singleprogram transport streams through the LAN 160.

The tech services module 122 may also be in communication with the modulator 170 to provide configuration and feedback for the modulator 170.

The output of the modulator is in communication with an uplink RF system (URFS) 172. The uplink RF system 172 generates the uplink signal 16 as illustrated in FIG. 1. The uplink RF system may include the antenna 50 of FIG. 1.

It should be noted that various configurations of the block diagrammatic view illustrated above, may be provided. For example, should the output of the encoder 154 not be IP ready, the IP LAN 160 may be removed and a direct connection between an encoder and the multiplexing splicing system 166 may be provided. Further, the advance broadcast monitoring system 124 may also be eliminated.

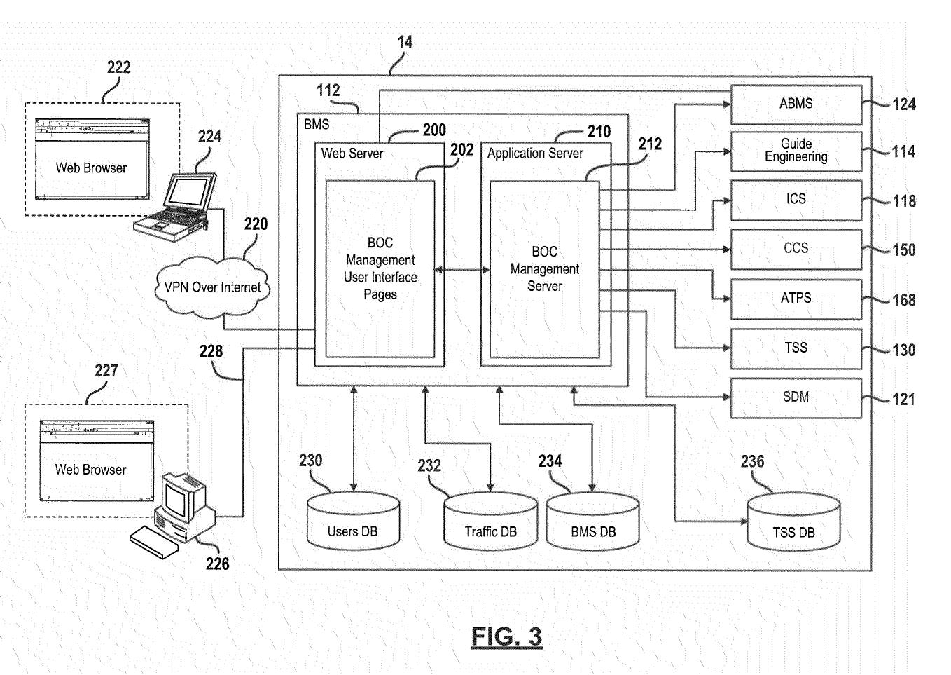

Referring now to FIG. 3, the broadcast system 14 is illustrated in further detail with the broadcast operation channel management system 112 also illustrated in further detail.

The BMS may include a web server 200 that is used to provide broadcast operation channel management pages 202. The BMS 112 may also include an application server 210 for providing various information to other broadcast components within the broadcast system 14. For example, the management server 210 may be in communication with the advance broadcast monitoring system 124 through XML HTTP or TCP/IP. The broadcast operation channel management server 212 may be in communication with guide engineering 114 through an email or other types of communication. The ICS system 118 may receive channels and channel assignments using XML HTTP. The content channel identifies may be communicated directly to the ICS 118 from the BMS 112. File copies may also be provided to the transport processing system 168 which may be in various formats. As will be further described below, each of the broadcast system components may receive broadcast operation channel data in various formats and may also receive different data depending on the system.

The web server 200 may issue various management or user interface pages 202 over the Internet 220 or other communication network. A user interface 222 may be generated on a computer 224 through which the changing of various data may be provided. It should be noted that the computer 224 may represent a home computer, or other system, of a supervisor who is responsible for maintaining the system. The network 220 may be a virtual private network over the Internet 220.

A computer 226 in communication with the web server 200 may also be provided information through a network 228. The network may be an internal LAN or the like and may be located in an office environment that includes the broadcast system 14. Again, a user interface 230 may be used to interface with and change various data within the broadcast system. As will be noted below, a secure login may be provided for users of the computer 224 and 226.

The BMS system 112 may be in communication with a user database 230, a traffic database 232, a BMS database 234 and a traffic and scheduling system database 236. The user database may include various information about users of the system. The BMS database may include various bit rate allocation charts including a security status of each user. The traffic database may include information about various channels, whereas the BMS database may include the bit rate allocation chart data. The traffic and scheduling database 236 may include various traffic scheduling data for the broadcast system. The contents and interaction of the various databases will be evident as set forth below.

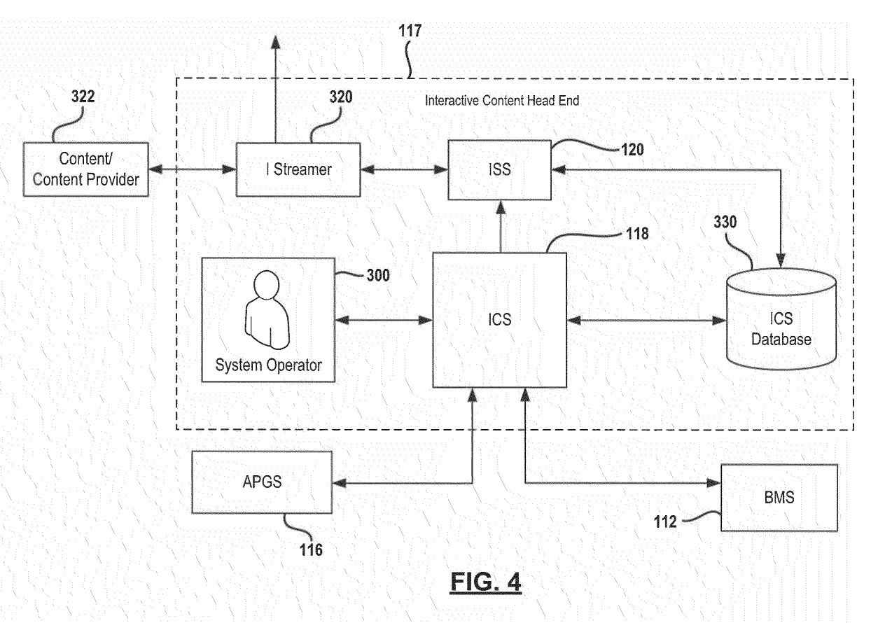

Referring now to FIG. 4, the interactive head end 117 is illustrated in further detail. As was illustrated in FIG. 2, the interactive content scheduler (ICS) 118 is in communication with an interactive streaming server (ISS) 120. The interactive content head end 117 is used to configure, schedule and broadcast a stream of data and metadata. A system operator 300 that is in communication with the ICS 118 may perform various tasks including obtaining content channel configurations, modifying content channel flags, creating a streaming service, deleting a streaming service, associating content channels to streaming services, disassociating content channels from streaming services, creating a reservation for a streaming service, deleting a reservation from a streaming service and managing changes in configurations of the system. The ICS 118 may be in communication with an ICS database 330 that is used to store data for channel configurations, the streaming service, and various other parameters of the system. The ICS database 330 is also in communication with the ISS 120.

The ISS 120 is also in communication with an interactive streamer (I streamer 320). The I streamer 320 receives content from a content provider 322 and provides the content, in the case of a satellite system to the transport processing system 168.

The interactive content schedule 118 is also in communication with the advance program guide system 116 and the broadcast operation channel management system 112. Further details of the interaction of the head end 117 with the APGS 116 and the BMS 112 will be further described below.

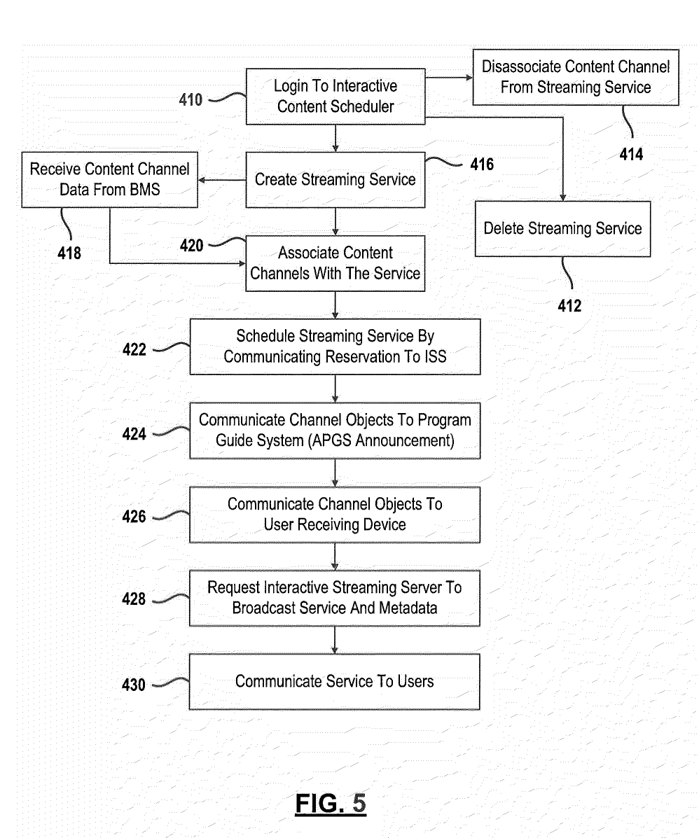

Referring now to FIGS. 4 and 5, the operation of the interactive content scheduler 118 and the associated components within the head end 117 are described in further detail. In step 410, the system operator 300 logs into the interactive content scheduler. The interactive content scheduler 118 may be a web-based system that provides a user interface for logging into the system. The user interface may include an identifier and a password. By providing a login ID and password, a high level of security may be provided to the system. By providing a password and login identifier, unauthorized users may be prevented from accessing the system.

In step 412, the interactive content scheduler may be used for deleting streaming services. Streaming services are the broadcasting of program streams such as interactive program streams. Streaming service may include providing data, video or audio or any combination thereof The timing and content sources are all included When deleting streaming services the various streaming services may be displayed on a web page as will be illustrated below. The system operator then selects a service and issues a delete command to remove the streaming service from the list of streaming services.

After login, the user may also select to disassociate a content channel from a streaming service. To perform this, the system operator submits a request to display streaming services. A list of streaming services is provided and displayed on the user interface. The user selects one streaming service and its associated interactive content channels. The user selects an interactive content channel and issues a request to disassociate that content channel. The interactive content scheduler then removes the association of the interactive content channel from the streaming service.

Referring back to step 410, after login the system operator may also be used to create a streaming service in step 416. To create a streaming service, the content channel data is obtained from the broadcast operation channel management system 112. Content channel configuration data may be obtained at the request of the system operator 300 or automatically upon the changing of the content channel configuration data within the BMS 112. With a user-initiated request, the ICS 118 sends a request to the BMS 112 for an entire set of interactive channel data. In the case of automatic sending, the BMS sends the content channel configuration to the ICS. Various data may be included in the content channel configuration data. The content channel configurations may include a start time, a stop time, a site identifier, a network identifier, a transponder identifier, a service channel identifier (SCID) and a content channel configuration bit rate. Once the ICS 118 receives the content channel configuration data, the content configuration channel data may be stored and displayed to the system operator. If new and updated content channel configurations are provided, older files may be updated. A list of configurations may be displayed for each interactive content channel when requested.

In step 420, channels are associated with the streaming service. This may be performed by the system operator submitting a request to display streaming services. An example of a user interface will be provided below. One of the streaming services is selected by the operator and the operator adds an interactive channel by requesting a list of interactive channels and selecting a content channel and issuing a request to associate the interactive content channel with the streaming service.

Once a change has been made or a streaming service added between the content channels and streaming services, a reservation may be communicated to the ISS 120. The actual reservation may be stored on the ICS database 330 and a communication such as a change in reservation message or reservation message may be communicated to the ISS 120 from the ICS 118 through a message broker. The streaming service may have various streaming service data that includes a provider identifier, a provider name, a content channel name, a content channel type, a multi-packet transport (MPT) frame, an IP address, an IP mask, the type of error detection, a port start, a port end and a digital storage media command and control (DSMCC) universal research locator (URL). Both the IP address and the DSMCC URL may be constructed using the content provider identifier and the service identifier. It should be noted that some or all of the data listed above may be included in the streaming service data.

The reservations for the streaming service may include various data including a reservation ID, a start time, a stop time, an uplink site identifier, a network identifier, a satellite transponder identifier, a service channel identifier and a reservation bit rate. In step 424, channel objects are communicated to the program guide system. The channel objects may be contained in an announcement that contains various channel data. The channel objects include various data about the content channel so that the data may be included in a program guide and so that the user device will have the information to tune to the channel. The start and stop time, content channel name or description and other information may be provided. The channel objects may also include an application flag and a record control flag. The application flag indicates when a user device is to start the application for receiving the streaming data. The record flag indicates whether or not the stream is recordable. The channel objects are then communicated to the user device 426. In a satellite system, the satellite may be used to broadcast the channel objects. Other methods for communicating the channel objects to the user device may include a wireless communication system, an Internet-based communication system, a wired communication system or the like.

Based on the reservation, the interactive streaming server 120 may command the I-streamer to broadcast the streaming service and the metadata. The streaming server may packetize the data. In step 430, the streaming service and metadata are communicated to the user devices and may be tuned by the user device in response to the data provided in the channel objects communicating the program guide.

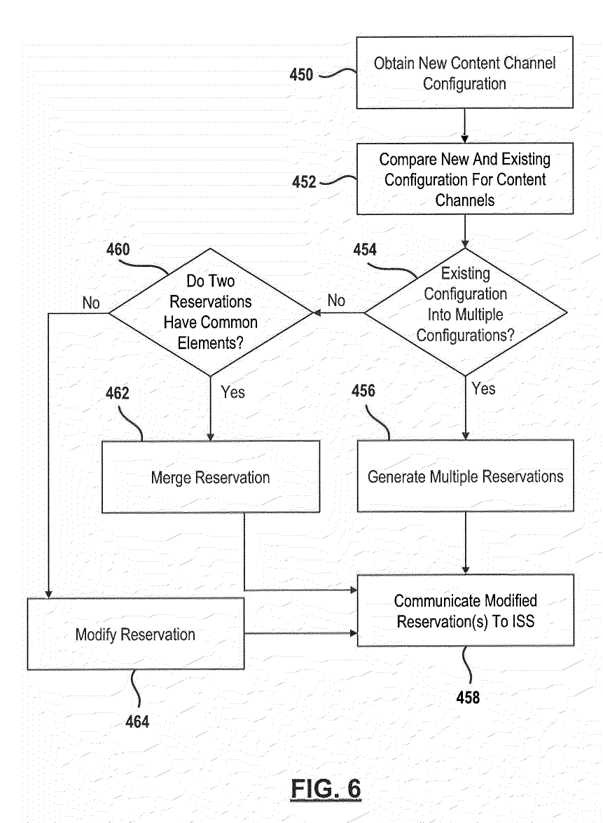

Referring now to FIGS. 4 and 6, a method for managing changes in configurations is set forth. In step 450, the interactive content scheduler obtains content channel configurations for new content channel configuration files. The ICS 118 compares to new and existing configurations of the same content channels in step 452. In step 454, for each content channel, if an existing configuration is changed into multiple configurations with a different network, transponder or service channel identifier, the ICS modifies the reservations of the streaming services where the content channel is the primary content channel. The ICS 118 splits the original reservation into multiple reservations, each inheriting the uplink site, the network, the transponder and the service channel identifier from its matching configuration. Generating multiple configurations is performed in step 456. The modified reservations may be communicated to the interactive streaming server 120. As mentioned above the direct communication of the reservation may not be provided. The reservation may be stored in the ICS database 330 and a notification provided from the ICS 118 to the ISS 120 that a reservation has been modified.

Referring back to step 454, if existing configurations are not set forth, two existing configurations having common elements may be combined in step 460. In step 460, if two reservations have common elements, the reservations may be merged in step 462. Merged reservations may be merged if they are continuous, have the same bit rate and their matching configurations have the same uplink site, network, transponder and service channel identifier. Once a reservation has been changed in step 462, step 458 is performed in which the ISS is notified of the changed reservation.

Referring back to step 460, if a reservation has been modified in step 464, then notification may be sent to the ISS 120. This is an optional step. Various changes to various portions of the data for the reservation may be made to invoke a modified reservation in step 458.

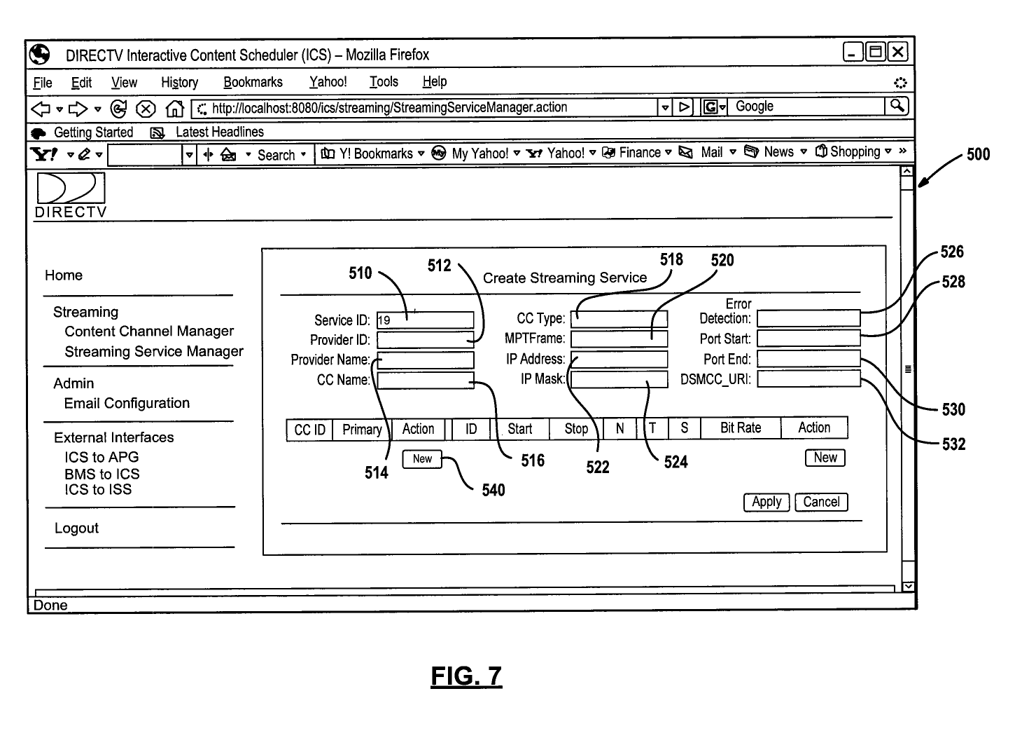

Referring now to FIG. 7, an example of a user interface 500 for changing or creating a streaming service is set forth. As is illustrated, the operator 300 may enter various data into the user interface 500. For example, a service identifier may be provided in box 510, a provider identifier may be provided in box 512, a provider name may be provided in box 514, a content channel name may be provided in box 516, a content channel type may be provided in box 518, an MPT frame may be provided in box 520, an IP address may be provided in box 522, an IP mask may be provided in box 524, an error detection box may be provided in box 526, a port start box may be provided in box 528, a port and box may be provided in box 530 and a DSMCC URL may be provided in box 532. To change the display of the streaming service, the “new” box 540 may be selected. The service ID may be automatically generated by the system for the next available service ID that is available in box 510. A content channel maybe associated with a streaming service.

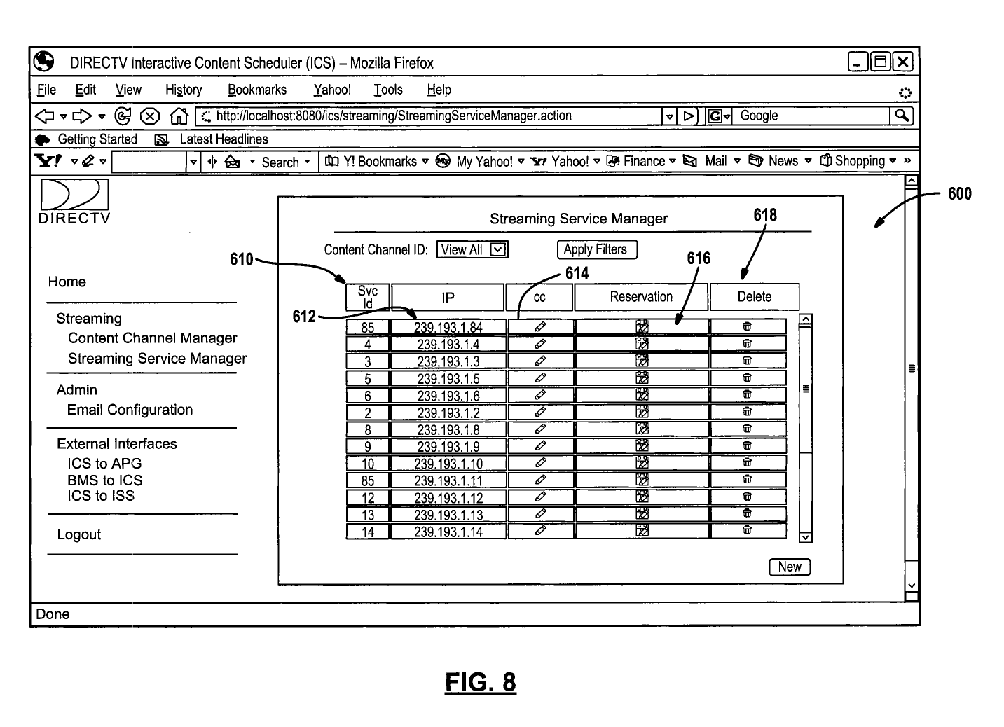

Referring now to FIG. 8, a streaming service manager user interface 600 is illustrated. The streaming service manager provides a list of streaming service identifiers that include service identifiers 610, IP addresses 612, a content channel selector 614, a reservation editor 616 and a delete column 618 that is used for deleting a content channel. By selecting one of the rows in the user interface 600, the content channel is associated with the new streaming service. The first selection is the primary channel selection.

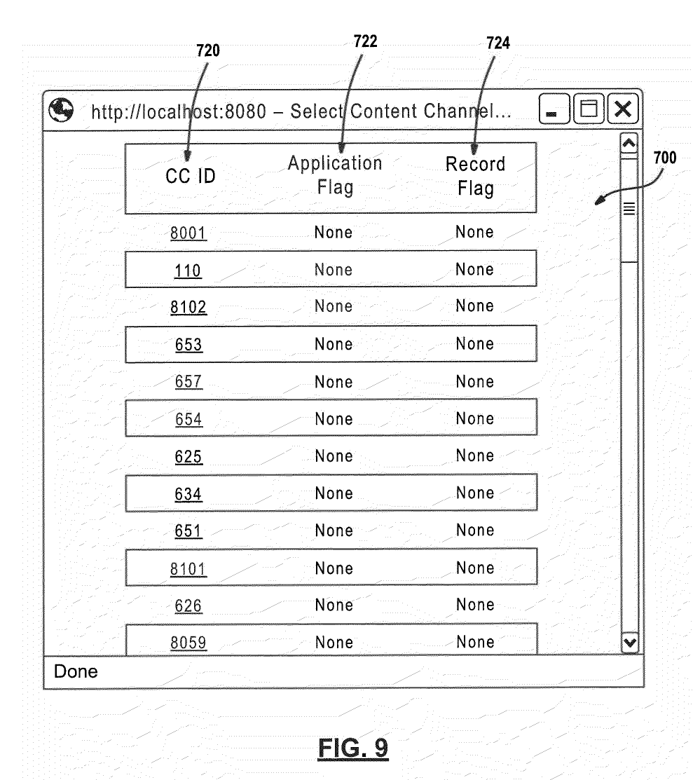

Referring now to FIG. 9, by selecting one of the edit icons in column 614, the user interface 700 is provided in which the content channels may be edited. As can be seen, a content channel identifier column 720 is provided next to an application flag column 722 and a record flag column 724. The status of the application flags and record flags are provided for each of the content channels. By selecting one of the content channel identifiers in column 720, a content channel editor may be generated.

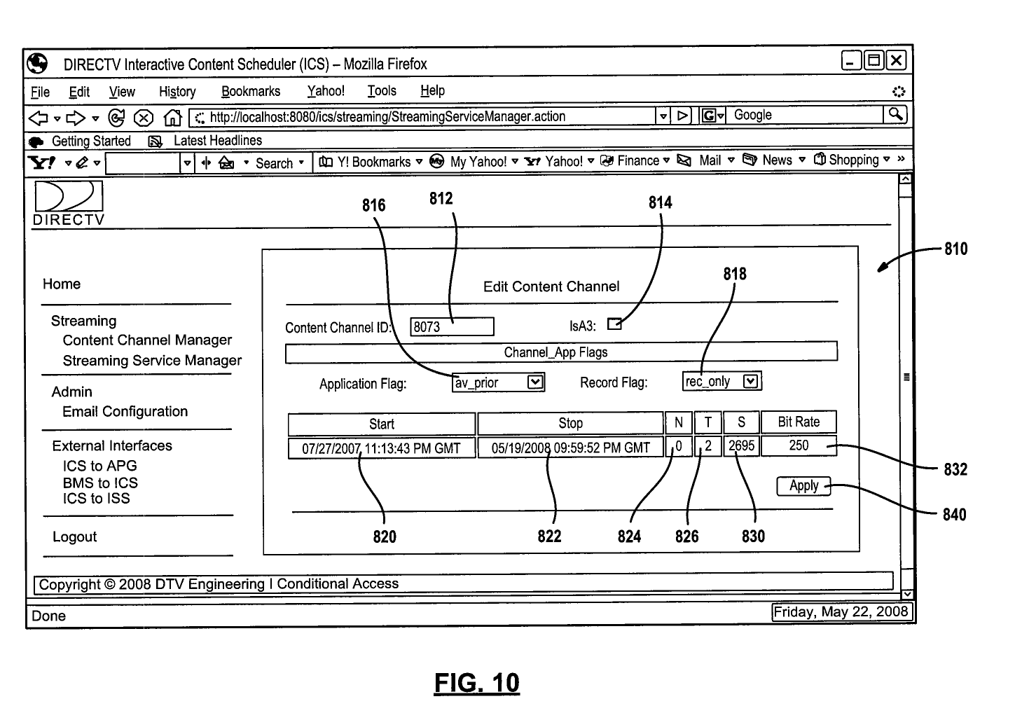

Referring now to FIG. 10, a content channel generator user interface 810 is illustrated. In this example, a content channel identifier box 812 is provided. If the channel is an A3 channel, an A3 checkbox may be provided at 814. The application flags for the content channel may be selected by the pull-down box 816. The record flag may be selected by a pull-down box 818. The start time may be provided in the start time box 820, the end time may be provided in the end time box 822, the network box may provide the network identifier in box 824, the transponder box 826 may provide a transponder identifiers an SCID box 830 may provide the service channel identifier and the bit rate box 832 may provide the bit rate for the interactive channel. By selecting one of the boxes, the data may be changed by selecting the apply box 840. In one example, the application flag and record flag are the editable fields.

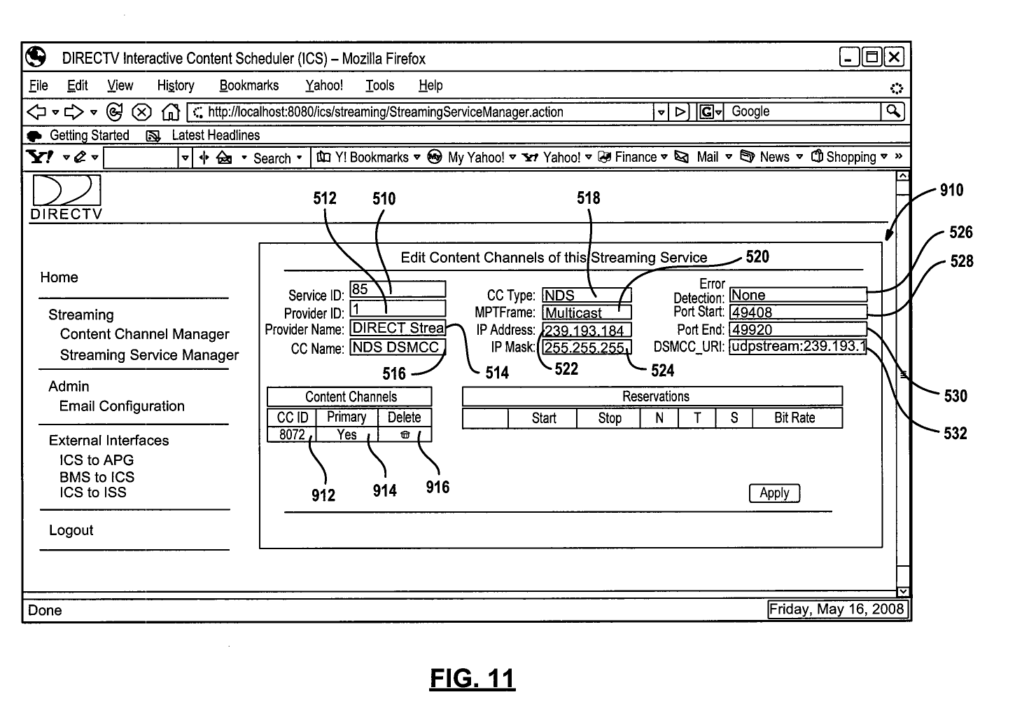

Referring now to FIG. 11, a user interface similar to that illustrated above with respect to FIG. 7 is illustrated. In FIG. 11, the user interface 910 includes the same boxes 510-532 as those illustrated in FIG. 7 with data therein. Therefore the boxes 510-532 will not be described again. Boxes 510-532 are identical to those in FIG. 7 with data therein. In this embodiment though, the content channel identifier may be provided in box 912, whether or not the content channel is a primary channel may be provided in box 914 and whether or not the content channel may be deleted may be provided in box 916.

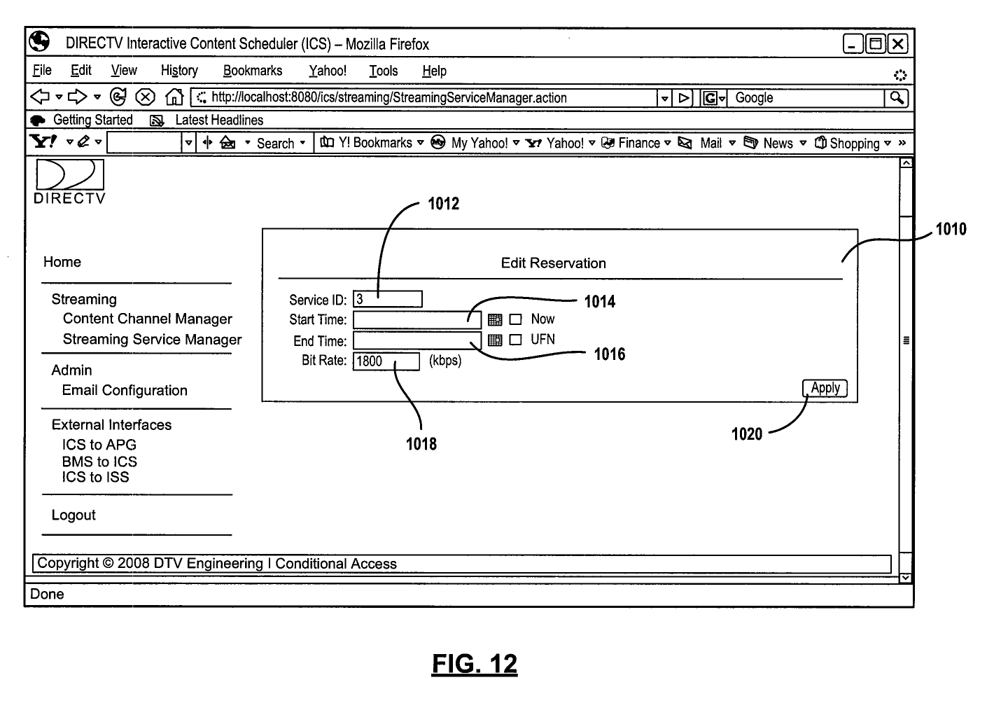

Referring now to FIG. 12, a method for creating a reservation is set forth in the user interface 1010. The user interface may include a service ID box 1012 for identifying the service, a start time box 1014, an end time box 1016 and a bit rate box 1018. A reservation may use the same network, transponder, service channel identifier of the primary content channel associated with the streaming service. The separate boxes may not be listed for these items. By placing the cursor in one of the boxes and typing in new data, the reservation may be changed by selecting the “apply” box 1020.

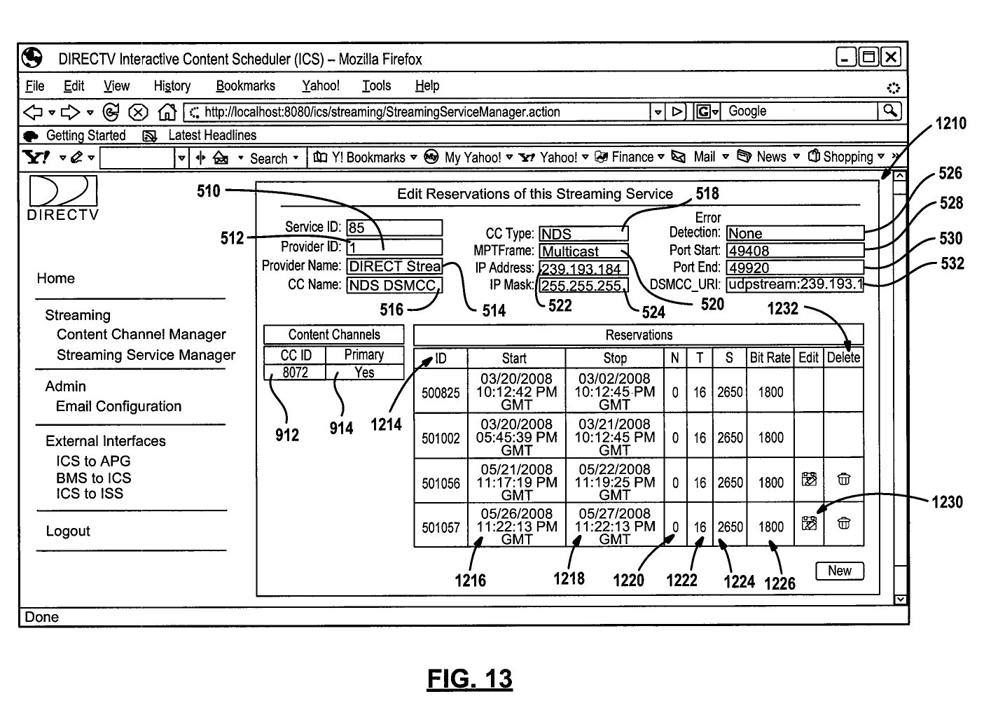

Referring now to FIG. 13, an example of a user interface 1210 for editing reservations of a streaming service is illustrated. The top portion of the user interface 1210 may include the same identifying boxes as FIGS. 7 and 11. Therefore, description of these is not provided. A content channel identifier 912 and a primary channel indicator 914 are identical to those illustrated above in step 11. The reservation portion 1212 may include various boxes for identifying various data. For example, data for various reservation identifiers may be provided in the identifier column 1214, the start time may be provided in the start column 1216 and the stop time may be provided in the stop column 1218. The network identifier may be provided in column 1220, the transponder identifier in column 1222 and the service channel identifier in column 1224. A bit rate column 1226 may also be provided. An edit column 1230 may be used to select a particular reservation for editing. A delete column 1232 may provide delete icons for deleting a particular reservation. FIG. 13 illustrates that multiple reservations may be split from a single reservation if a content channel configuration takes place.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A method for comprising:
receiving content channel data from a broadcast channel management system;
forming a streaming service from streaming service data and content channel data; and
in response to the streaming service, communicating content to user devices.

2. A method as recited in claim 1 wherein receiving content channel data comprises receiving a content channel start time, a content channel stop time and content channel bit rate.

3. A method as recited in claim 1 wherein receiving content channel data comprises receiving a content channel start time, a content channel stop time, a content channel bit rate, a transponder identifier, and a service channel identifier.

4. A method as recited in claim 1 wherein receiving the content channel data comprises receiving the content channel data when a content channel change occurs at the broadcast channel management system.

5. A method as recited in claim 1 wherein receiving the content channel data comprises receiving the content channel data in response to a user interface generated request.

6. A method as recited in claim 1 wherein receiving content channel data from a broadcast channel management system comprises receiving content channel data directly from the broadcast channel management system using a content channel configuration signal.

7. A method as recited in claim 1 wherein forming a streaming service from streaming service data comprises forming the streaming service from a service channel identifier or name, a content channel name or identifier.

8. A method as recited in claim 1 further comprising forming a reservation corresponding to the streaming service.

9. A method as recited in claim 8 wherein forming a reservation comprises forming a reservation from a network identifier, a service channel identifier and a transponder identifier from the content channel data.

10. A method as recited in claim 8 further comprising after forming a reservation, storing the reservation in a database and communicating message to an interactive streaming server in response to storing the reservation.

11. A method as recited in claim 1 wherein communicating content comprises communicating interactive content.

12. A method as recited in claim 1 wherein communicating content comprises communicating content through a satellite.

13. A method as recited in claim 1 wherein communicating content comprises communicating content through a transport processing system.

14. A method as recited in claim 1 wherein communicating content comprises communicating content through a broadband system.

15. A method as recited in claim 1 wherein forming a streaming service from streaming service data comprises forming a streaming service from a provider identifier and a content channel identifier.

16. A method as recited in claim 1 wherein forming a streaming service from streaming service data comprises forming a streaming service from at least three of one of a provider identifier, a provider name, a content channel name and a content channel type.

17. A method as recited in claim 1 further comprising communicating a channel object corresponding to the streaming service to a program guide system.

18. A method comprising:
receiving content channel data from a broadcast channel management system and an interactive content scheduler;
forming a streaming service from streaming service data and content channel data at the interactive content scheduler;
forming a reservation corresponding to the streaming service;
storing the reservation in a database;
communicating a message to an interactive streaming server in response to the interactive content scheduler;
in response to the reservation, communicating content to user device using the interactive content scheduler; and
communicating a channel object to a program guide system corresponding to the streaming service.

19. A method as recited in claim 18 wherein receiving content channel data comprises receiving a content channel start time, a content channel stop time and content channel bit rate.

20. A method as recited in claim 18 wherein receiving content channel data comprises receiving a content channel start time, a content channel stop time, a content channel bit rate, a transponder identifier, and a service channel identifier.

21. A method as recited in claim 18 wherein receiving the content channel data comprises receiving the content channel data when a content channel change occurs at the broadcast channel management system.

22. A method as recited in claim 18 wherein receiving the content channel data comprises receiving the content channel data in response to a user interface generated request.

23. A method as recited in claim 18 wherein forming a streaming service from streaming service data comprises forming the streaming service from a provider identifier or name, a content channel name or identifier.

24. A system for communicating with a user device comprising:
an interactive head end;
a broadcast channel management system communicating content channel data to the interactive head end;
said interactive head end forming a streaming service in response to the content channel data and communicating interactive content to the user device in response to the streaming service.

25. A system as recited in claim 23 wherein the interactive head end comprises an interactive content scheduler in communication with an interactive streaming server.

26. A system as recited in claim 24 wherein the interactive head end comprising a data base, said interactive scheduler generating a reservation in response to the content channel data and the streaming service, storing the reservation in the database an communicating a reservation message to the interactive streaming server in response to the message.

27. A system as recited in claim 24 wherein the interactive streaming server communicates interactive content to the user device in response to the reservation through an interactive streamer.

28. A system as recited in claim 24 wherein the interactive content comprises at least one of audio, data or video.

29. A system as recited in claim 24 wherein the interactive content comprises audio, video and data.

30. A system as recited in claim 24 further comprising a program guide system receiving channel object from the interactive head end formed in response to the streaming service.
